(19) United States
(12) Patent Application Publication
(10) Pub. No.: US 2014/0279620 A1
(43) Pub. Date: Sep. 18, 2014

(54) SYSTEMS AND METHODS FOR DETERMINING ENROLLMENT PROBABILITY

(71) Applicant: Uversity, Inc., San Francisco, CA (US)

(72) Inventors: Lane Lillquist, San Francisco, CA (US); Rich Niles, San Francisco, CA (US)

(73) Assignee: Uversity, Inc., San Francisco, CA (US)

(21) Appl. No.: 13/917,481

(22) Filed: Jun. 13, 2013

Related U.S. Application Data
(60) Provisional application No. 61/787,710, filed on Mar. 15, 2013.

(51) Int. Cl. G06Q 50/20

(52) U.S. Cl. CPC G06Q 50/2053; G06Q 10/063
USPC 705/319

(57) ABSTRACT

Systems and method are provided for determining an enrollment probability. Prior candidate data is received for an institution. Activity of a current candidate on a social media site is monitored, where the current candidate is an applicant of the institution. An enrollment probability for the current candidate is determined based on the prior candidate data and the current candidate activity on the social media site.

### CROSS-REFERENCE TO RELATED APPLICATIONS

This application claims priority under 35 U.S.C. §119(e) to U.S. Provisional Patent Application No. 61/787,710 filed Mar. 15, 2013, and entitled “Systems and Methods for Determining Enrollment Probability,” which application is incorporated by reference herein in its entirety.

### BACKGROUND

Many institutions have enrollment goals for a particular class year. To achieve these goals, institutions plan and recruit students so that they enroll in their institution. To effectively coordinate recruiting efforts, institutions like to refer to data that can help focus their efforts towards various prospects. Many people are members of some sort of social media website, and via these sites, users express their feelings, thoughts, likes, and dislikes. In the past, institutions have analyzed demographic data available to them from their past classes. In addition, institutions that do not have such data have to accumulate the data over the course of several years' worth of student enrollments. Therefore, it is beneficial to leverage social data in coordinating recruitment efforts and making useful data available to institutions that do not have past years' data.

### BRIEF DESCRIPTION OF THE DRAWINGS

Some embodiments are illustrated by way of example in the accompanying drawings and should not be considered as a limitation of the inventive subject matter:

FIG. 1 is a network diagram depicting a system for determining an enrollment probability according to some embodiments.

FIG. 2 is a block diagram showing an enrollment probability predictor implemented in modules according to some embodiments.

FIG. 3 is an example flow diagram showing the functionalities or operations of an enrollment probability predictor according to some embodiments.

FIGS. 4-8 are user interface diagrams showing examples of user interface (UI) screens provided on a client device associated with an enrollment probability predictor according to some embodiments.

FIG. 9 is a diagram showing example database tables and example database fields in which the methods and systems described herein may be implemented according to some embodiments.

FIG. 10 is a diagrammatic representation of a machine in the example form of a computer system within which a set of instructions for causing the machine to perform any one or more of the methodologies discussed herein may be executed according to some embodiments.

### DETAILED DESCRIPTION

Described in detail herein is a system and method for determining an enrollment probability of a student enrolling in an institution. First, reference enrollment probabilities are determined from reference data. Reference data is collected for students who were accepted in past recruitment cycle(s). Such students are invited to join an institution's social media site. Data such as number of friends before joining, number of friends after joining, days active, amount of information in profile is collected. This information is used in calculating a reference enrollment score. Reference enrollment scores are calculated for all students for a reference institution for the past recruitment or enrollment cycle. These reference enrollment scores are ranked and sorted into reference bins. For example, the top 10% of scores form the first reference bin; the next 10% form the second reference bin, and so on. For each reference bin an enrollment probability is calculated. The enrollment probability comprises the percent of students that actually enrolled in the institution out of the total number of students in the reference bin. This is the reference enrollment probability. After determining the reference data, the next step is to determine an enrollment probability for a current accepted student for a particular institution.

A current accepted student is invited to join a social media site for the institution. The social media site may be a dedicated social site for the institution, such that users can join the site only by invitation, and the information on the site is related to the institution. Just as data was collected for past-accepted students, data is collected for the current students. This data includes information such as number of friends before joining, number of friends after joining, days active, amount of information in profile, etc. An enrollment score for the current student is calculated based on the collected data. The enrollment score may be calculated as a weighted sum or a weighted average. Enrollment scores are calculated for all current accepted students for a target institution. These enrollment scores are ranked and sorted into bins in a similar manner as the reference bins. For example, the top 10% are sorted into a first bin; the next 10% are sorted into a second bin, and so on. These bins may not have the same number of students as the reference bins for a reference institution. However, the number of bins for current students of a target institution may be the same as the number of reference bins. After ranking and sorting, each current student is assigned to a bin. The current student's bin is matched with a reference bin, and the reference enrollment probability of the matched reference bin is assigned to the current student as his enrollment probability.

In this manner, data collected for prior candidates or students is ranked and sorted so that it can be mapped to current candidates or students. Prior candidate data can be used to predict enrollment probability for current students based on similarity of current student's data to prior candidate data. In some situations, a target institution may not have prior candidate data. In that case, a reference institution is chosen to determine the enrollment probability for current students. The reference institution may be chosen based on demographic similarities, location similarities, and/or enrollment yield. Enrollment yield is a percent of students that enroll in the institution of the accepted students. When a target institution has prior candidate data, then that data is used to calculate reference enrollment scores and reference enrollment probabilities. By using similarly situated reference institutions when past data is not available for a target institution, institutions that do not have past data do not have to wait a few years to have enrollment probabilities to plan their recruitment efforts.

Additionally, the enrollment probability for a current student is calculated on a daily basis. The enrollment probability of the current student is also stored every day in a database, and the institution views, via a user interface, the most current enrollment probability for the student. Further, the reference enrollment probabilities are calculated for a past enrollment cycle ending on the current day of last year (today minus one year). For example, if an enrollment probability for a current student is being calculated on Mar. 12, 2013, then reference data collected for prior candidates starting from the past enrollment cycle (typically November 2011) until Mar. 12, 2012 is used to calculate the reference enrollment probability. As such, the enrollment probability predictor looks at data at similar times in an enrollment cycle. This is beneficial in predicting a more accurate probability because students act differently at different time points within an enrollment cycle. For example, around April, students are likely to make decisions on which institution they want to enroll in. Therefore, data collected in April is a stronger indicator of a student's likelihood of enrolling in an institution.

Furthermore, an institution that does not have data available for prior candidates can still benefit from the enrollment probability predictor mechanism. For such target institutions, reference data from a reference institution is used to calculate enrollment probabilities for the current accepted students of the target institution. The reference institution may be chosen based on enrollment yield. The enrollment yield is the number of students who actually enroll verses the number of students who are admitted to the school or invited. The reference schools may be schools that have good previous years' student data and the data is trustworthy. If the target institution has past year student data, then that data is used as reference data. Thus, an institution, even though it does not have past data, can still use enrollment probabilities to focus its recruitment efforts.

The enrollment probability predictor can be used by any institution that enrolls students, such as, for example, public universities, private universities, technical colleges, community colleges, 2-year colleges, traditional 4-year colleges, graduate universities, online universities, for-profit universities, non-profit universities, and the like. Furthermore, the enrollment probability predictor may use data from prospective students and applicants as well.

The following description is presented to enable a person skilled in the art to create and use a computer system configuration and related method and article of manufacture to receive user data and determine enrollment probability of a candidate enrolling in an institution. Various modifications to the example embodiments will be readily apparent to those skilled in the art, and the generic principles defined herein may be applied to other embodiments and application without departing from the spirit and scope of the disclosure. Moreover, in the following description, numerous details are set forth for the purpose of explanation. However, one of ordinary skill in the art will realize that the disclosure may be practiced without the use of these specific details. In other instances, well-known structures and processes are shown in block diagram form in order not to obscure the description of the enrollment probability predictor mechanism with unnecessary detail. Thus, the present disclosure is not intended to be limited to the embodiments shown, but is to be accorded the widest scope consistent with the principles and features disclosed herein.

FIG. 1 illustrates a network diagram depicting a system 100 for determining enrollment probability, according to an example embodiment. The system 100 can include a network 105, a client device 110, a client device 115, a client device 120, a client device 125, an application server 130, an institution server 135, a social media site server 140, a database(s) 150, and a database(s) server 155. Each of the client devices 110, 115, 120, 125, application server 130, institution server 135, social media site server 140, database(s) 150, and database server(s) 155 is in communication with the network 105.

In an example embodiment, one or more portions of network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The client devices 110, 115, 120, 125 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of client devices 110, 115, 120, 125 may connect to network 105 via a wired or wireless connection. Each of client devices 110, 115, 120, 125 may include one or more applications (also referred to as “apps”) such as, but not limited to, a web browser, messaging application, electronic mail (email) application, notification application, an enrollment probability predictor application described herein, and the like. In some embodiments, the enrollment probability predictor application included in any of the client devices 110, 115, 120, 125 may be configured to locally provide a user interface and communicate to the application server 130 to receive an enrollment probability for a student.

In some embodiments, the application server 130 performs the functionalities described herein. The application server 130 receives prior candidate data, determines reference enrollment scores, reference bins, and reference enrollment probabilities. The application server 130 further receives current student data, and determines enrollment scores and enrollment probabilities for the current student for an institution.

Each of the application server 130, institution server 135, social media site server 140, database(s) 150, and database server(s) 155 is connected to the network 105 via a wired connection. Alternatively, one or more of the application server 130, institution server 135, social media site server 140, database(s) 150, and database server(s) 155 may be connected to the network 105 via a wireless connection. Although not shown, database server(s) 155 can be (directly) connected to database(s) 150, or the application server 130, institution server 135, and social media site server 140 can be (directly) connected to the database server(s) 155 and/or database(s) 150. The application server 130, institution server 135, and social media site server 140 each comprises one or more computers or processors configured to communicate with client devices 110, 115, 120, 125 via network 105. The application server 130, institution server 135, and social media site server 140 hosts one or more applications or websites accessed by the client devices 110, 115, 120, 125 and/or facilitates access to the content of database(s) 150. Database server(s) 155 comprises one or more computers or processors configured to facilitate access to the content of database(s) 150. Database(s) 150 comprises one or more storage devices for storing data and/or instructions for use by application server 130, institution server 135, social media site server 140, database server(s) 155, and/or client devices 110, 115, 120, 125. Database(s) 150, application server 130, institution server 135, social media site server 140, and/or database server(s) 155 may be located at one or more geographically distributed locations from each other or from client devices 110, 115, 120, 125. Alternatively, database(s) 150 may be included within application server 130, institution server 135, social media site server 140 or database server(s) 155.

FIG. 2 is a block diagram 200 showing an enrollment probability predictor implemented in modules according to an example embodiment. The modules may be implemented in client devices 110, 115, 120, 125 and/or application server 130. The modules may comprise one or more software components, programs, applications, apps or other units of code base or instructions configured to be executed by one or more processors included in client device 110, 115, 120, and/or 125 and/or application server 130. Although modules 210-240 are shown as distinct modules in FIG. 2, it should be understood that modules 210-240 may be implemented as fewer or more modules than illustrated. It should be understood that any of modules 210-240 may communicate with one or more components included in system 100, such as application server 130, institution server 135, social media site server 140, database(s) 150, database server(s) 155, or client devices 110, 115, 120, 125. The modules 210-240 include a data collection module 210, a reference data module 220, an enrollment prediction module 230, and a display configuration module 240. Operations performed by these modules are described in further detail below with reference to flow diagrams.

FIG. 3 illustrates an example flow diagram 300 showing the operations of the enrollment probability predictor according to some embodiments. FIGS. 4-8 illustrate examples of user interface (UI) screens provided on a client device 110, 115, 120, or 125 associated with an enrollment probability predictor application according to some embodiments. FIGS. 2-8 are described below in conjunction with each other to describe one or more embodiments of the enrollment probability predictor. The enrollment probability predictor disclosed herein facilitates determining an enrollment probability of a student enrolling in an institution based on student data including social data. The enrollment probability predictor mechanism may also be referred to herein as an enrollment probability application, enrollment score mechanism, enrollment score prediction, enrollment intelligence mechanism, and similar terms.

At a block 305 of FIG. 3, the data collection module 210 of FIG. 2 can receive data for prior candidates of an enrollment cycle for an institution. Prior candidates can include students who were accepted as part of an admission process to an institution. Some of these accepted students may have enrolled in the institution, while other students may have decided not to enroll in the institution. In alternative embodiments, prior candidates may include prospective students for the institution and applicants who applied to the institution. An enrollment cycle is a period of time during which data is collected for a user. An enrollment cycle starts when the last admissions enrollment cycle started for the institution and ends on today minus a year. For example, if today is Mar. 10, 2013, then the enrollment cycle starts in November 2011 (when the institution's admissions cycle starts) and ends on Mar. 10, 2012. In some embodiments, the enrollment cycle begins on the first day that an admissions department of the institution starts accepting applications, and the enrollment cycle ends on the last day to enroll in the institution. In other embodiments, the enrollment cycle may begin on the day that the user submits an application for the institution. In other embodiments, the enrollment cycle may end on the day that the user enrolls in the institution. In an example embodiment, the enrollment cycle may be predefined. In alternative embodiments, the enrollment cycle may be configured by a developer of the application or an admissions administrator of the institution.

Prior candidates, such as accepted students for last year's class, are invited to join a dedicated social media site for the institution upon their acceptance to the institution. Data for prior candidates is obtained from the social media site. In some embodiments, the social media site may not be a dedicated site, but rather a page on a different entity's social media site like Facebook, for example. Data for prior candidates can include, but is not limited to, information regarding days that the user was active on the social site, the number of friends the user had on the site, the number of words in the user's posts on the social site, the amount of information filled out in the user profile, the number of communities joined, number of posts, number of visits, total minutes on the site, number of comments, number of times a user viewed his own profile, number of times a user viewed other users' profiles, number of questions posted, number of feed items signed up for, and the like. In some embodiments, the data collection module 210 may receive data from the social media site server 140.

In some embodiments, the data collection module 210 may receive data from the institution server 135. The institution server 135 may provide information about a prior candidate that may not be available on the social media site including, but not limited to, high school Grade Point Average (GPA), high school location, gender, user address, Scholastic Aptitude Test (SAT) scores, American College Test (ACT) scores, interested course of study, enrollment status (enrolled in institution or not; part-time or full-time), and information regarding deposits (when the deposit was received, the amount of deposit). The data collection module 210 may store the received data as corresponding to a user for the institution. The data collection module 210 may receive data for another prior candidate for the same institution, and store this data as corresponding to the institution. The data collection module 210 may receive data for a prior candidate of a second institution, and store the data as corresponding to a user for the second institution. As such, data regarding prior candidates may be stored as corresponding to respective institutions.

The data collection module 210 may write data to various database tables (discussed below and shown in FIG. 9) located on database(s) 150. For example, the data collection module 210 may write data for prior candidates to enrollment_statuses table 910, feed_items table 920, enrollment_scores table 930, facebook_friendships table 940, historical_requests table 950, users table 960, visits table 970, user_tag_keys table 980, and user_tags table 990.

At a block 310, the reference data module 220 determines reference enrollment scores for prior candidates based on the received data. The reference data module 220 may retrieve data from the various database tables (shown in FIG. 9) stored on the database(s) 150. The reference data module 220 uses the data received at block 305 as inputs for an algorithm for calculating an enrollment score for each prior candidate. In an example embodiment, the enrollment score for a prior candidate is calculated as a weighted sum of all the inputs. As discussed above, an input can include days that the user was active on the social site, the number of friends the user had on the site, the number of words in the user's posts on the social site, the amount of information filled out in the user profile, high school GPA, high school location, gender, user address, SAT scores, ACT scores, interested course of study, enrollment status, and the like. Ordinarily, the greater the amount and/or type of activity associated with a user, the higher the enrollment score for that user, but it is entirely possible that some factors would be negatively correlated with enrollment as well. The reference data module 220 determines reference enrollment scores for all available prior candidates for a given reference institution, and stores the reference enrollment scores as corresponding to the reference institution. In a similar manner, the reference data module 220 determines the reference enrollment scores for another reference institution, and stores these reference scores as corresponding to that reference institution. The reference enrollment scores may be numerical values between a pre-determined range.

At a block 315, the reference data module 220 ranks the reference scores numerically (e.g., from highest to lowest score). The reference data module 220 calculates reference enrollment scores for all available prior candidates of a reference institution. These reference enrollment scores are ranked numerically.

At a block 320, the reference data module 220 organizes the reference scores into reference bins or buckets. A bin or a bucket may be a logical collection of data, or a collection of reference scores in this case. The reference scores are placed in bins based on their ranking. The top n % reference scores are placed in the first bucket, the second n % of reference scores in the next bucket, and so on. In some embodiments, each bucket or bin has the same number of reference scores. It is understood that a reference bin may be a conceptual bin and that a reference bin need not literally be a bin in a separate application or data structure.

At a block 325, the reference data module 220 determines an enrollment probability for each of the reference bins. The enrollment probability is the percent of users in the bucket that enrolled in the institution of the total number of users that are in the bucket. The reference data module 220 may write the enrollment probability to the enrollment_scores table 910 of FIG. 9.

Blocks 330, 335, and 340 are similar to blocks 305, 310, 315, and 320 except the operations are performed for current candidates of an institution instead of the institution's prior candidates. At a block 330, the data collection module 210 receives data for a current candidate of an institution. A current candidate is an accepted student for the next class year. For example, a current candidate may be a student who applied to enroll in the institution for the Fall 2013 semester, and was accepted for the semester by the institution. In alternative embodiments, a current candidate may be a prospective student or a student who applied to the institution for enrollment. Current candidates, such as accepted students for the next semester or enrollment year, are invited to join a dedicated social media site for the institution upon acceptance by the institution. Data for current candidates is obtained from the social media site. In some embodiments, the social media site may not be a dedicated site, but rather a page on a social media site like Facebook, for example. Data for current candidates can include, but is not limited to, information regarding days that the user was active on the social site, the number of friends the user had on the site, the number of friends the user had before joining the dedicated site, the number of friends the user had after joining the dedicated site, the number of words in the user's posts on the social site, the amount of information filled out in the user profile, and the like. Data for current candidates may also include the number of communities joined, number of posts, number of visits, total minutes on site, number of comments, number of times the user viewed his own profile, number of times viewed others' profiles, number of questions posted, number of feed items signed up for, and the like. Such data may be written by the data collection module 210 to the visits table 970 of FIG. 9.

The number of days active on the social site can help determine the likelihood of the current candidate enrolling in the institution. For example, a user that is active for more days on the site is more likely to enroll in the institution than a user that is active for fewer days. Being active on the site can include logging into the site, checking posts, posting status updates on the site, making friends, and the like. If a user is active on the site, it can indicate that the user is interested in the institution, and is likely to enroll in the institution. The number of friends the user had before joining the dedicated site and after joining the dedicated site can help determine the likelihood of the user enrolling in the institution. For example, if the user makes more friends after joining the dedicated site, those friends may have been made because of the user's association with the institution, and the user may be more likely to enroll in the institution because of his friendships. The number of words in the user's posts on the social site can also help determine the likelihood of the user enrolling in the institution. For example, the more words the user includes in his post, the more interested the user may be in the institution. Similarly, the amount of information filled in the user's profile can also help determine the likelihood of the user enrolling in the institution. For example, the more information included in the user profile, the more interested the user may be in the institution.

In some embodiments, the data collection module 210 may receive data from the social media site server 140. For example, the data collection module 210 may receive information regarding friends of the current candidate, such as the number of friends, the names of friends, etc. In alternative embodiments, the data collection module 210 may receive information regarding days that the user was active on the social site, the number of friends the user had on the site, the number of words in the user's posts on the social site, the amount of information filled out in the user profile, the number of communities joined, number of posts, number of visits, total minutes on the site, number of comments, number of times a user viewed his own profile, number of times viewed others' profiles, number of questions posted, number of feed items signed up for, and the like. In other embodiments, the data collection module 210 may receive data from the institution server 135. The institution server 135 may provide information about a current candidate including, but not limited to, high school GPA, high school location, user address, SAT scores, ACT scores, interested course of study, and enrollment status (accepted, partial deposit made, full deposit made, etc.).

At a block 335, the enrollment prediction module 230 determines an enrollment score for each of the current candidates of the institution. The enrollment prediction module 230 uses the data collected in block 330 to determine the enrollment score for the user. For example, the enrollment prediction module 230 uses days that the user was active on the social site, the number of friends the user had on the site, the number of friends the user had before joining the dedicated site, the number of friends the user had after joining the dedicated site, the number of words in the user's posts on the social site, the amount of information filled out in the user profile, and the like. Such data may be retrieved by the enrollment prediction module 230 from the visits table 970 and facebook_friendships table 940 of FIG. 9. In some embodiments, the enrollment prediction module 230 may use high school GPA, high school location, user address, SAT scores, ACT scores, interested course of study, and enrollment status. The enrollment score may be calculated as a weighted sum of the inputs. The greater the amount and/or type of activity associated with a user, the higher the enrollment score for that user. In some embodiments, the enrollment score for the current candidate is calculated in the same way as the reference enrollment score for a prior candidate.

In some embodiments, the formula used to calculate the enrollment score is the same for all institutions. In other embodiments, the formula used to calculate the enrollment score is based on the type of institution. For example, there may be a different formula for a private university, a public university, a 2-year college, a traditional 4-year college, etc. In alternative embodiments, the formula used to calculate the enrollment score may be different between institutions or specified by the institution.

At a block 340, the enrollment prediction module 230 ranks and sorts the enrollment score for the current candidates into bins. The enrollment prediction module 230 may have multiple enrollment scores for different users for the institution for the next class year, and these scores are ranked numerically. The enrollment score for the current candidate is ranked numerically relative to other enrollment scores for other current candidates for the institution. After the enrollment scores are ranked, the enrollment scores are sorted into bins in a similar manner as discussed above for block 320. For example, the ranked enrollment scores for the current candidates are sorted into the same number and kinds of bins as the reference bins. As discussed above, a bin is a collection of data, in this case a bin is a collection of enrollment scores.

At a block 345, the enrollment prediction module 230 determines enrollment probability of the current candidate based on the reference bins. The current candidate is matched with a reference bin at block 345. Each reference bin has a corresponding enrollment probability as determined at block 325. The enrollment probability of the reference bin that the current candidate is matched to is the enrollment probability of the current candidate. For example, the reference bins are determined based on reference enrollment scores of prior candidates, and an enrollment probability corresponding to each of the reference bins is determined. The current candidate is mapped to a reference bin that has enrollment scores for prior candidates that are similar or have similar data as the current candidate. Therefore, the enrollment probability of the reference bin is a good estimation of the enrollment probability of the current candidate. The enrollment probability of the current candidate may be written by the enrollment prediction module 230 to the enrollment_scores table 930 of FIG. 9.

Alternative embodiments may comprise an additional module that is configured to create a formula or process for generating enrollment probabilities for current candidates. The additional module may use prior candidate data such as days that the user was active on the social site, the number of friends the user had on the site, the number of words in the user's posts on the social site, the amount of information filled out in the user profile, and the like to determine a formula or process to calculate enrollment probabilities. The formula or process may be determined using machine learning methods such as logistic regression analysis or neural network analysis. The formula or process determined by the additional module may be used by the enrollment prediction module 230 for determining the probability that the current candidate will enroll in the institution based on the current candidate activity.

In yet another embodiment, the additional module may be configured to use multi-dimensional methods to create a formula or process for generating probabilities for current candidates. For example, instead of a linear sorting of the reference enrollment scores into bins, the reference enrollment scores may be sorted into multi-dimensional bins. This method of sorting reference enrollment scores into multi-dimensional bins may be applied to the sorting of the current candidates' enrollment scores as well.

At a block 350, the display configuration module 240 sends the enrollment probability for the current candidate for display (or use in general by the institution such as storage, further analysis, etc.). For example, the display configuration module 240 may send the enrollment probability to display on a client device of an institution user. An institution user can be anyone that benefits from an enrollment probability for a student. For example, the institution user may include an admissions officer for the institution, an administrator for the institution, a counselor for the institution, and the like. The display configuration module 240 may configure the enrollment probability for current candidates for an institution to display in various formats. For example, the enrollment information may be displayed in a funnel format as shown in FIG. 4, in a line chart format as shown in FIG. 5, and by categories as shown in FIG. 7A. The display configuration module 240 may configure the enrollment probability for display based on the institution user's configurations. For example, the funnel format and line charts may be configured by a user as shown in FIG. 6, and the categories may be configured by a user as shown in FIG. 7B. The display configuration module 240 may also configure enrollment probability for display along with student information as shown in FIG. 8. The display configuration module 240 may retrieve data for display from the enrollment_scores table 930 and the users table 960 of FIG. 9.

FIG. 4 illustrates an example user interface 400 for viewing enrollment probabilities or scores for current candidates. The user interface 400 may show students that are likely to enroll at the bottom of the funnel, while the students that are not likely to enroll or are “on the fence” may be shown towards a top portion of the funnel in a color or manner different than the bottom portion of the funnel. The user interface 400 may also display a total number of students that are likely to enroll and that are on the fence. In an example embodiment, the user interface 400 may also display arrows indicating an increase or decrease in the number of students that are likely to enroll and that are on the fence relative to a previous time period (e.g., previous week).

FIG. 5 illustrates an example user interface 500 for viewing enrollment probabilities or scores for current candidates. The user interface 500 may show students that are likely to enroll and that are on the fence in a line chart format. One of the lines may represent students likely to enroll while another may represent students that are on the fence. The information may be displayed over a period of time. For example, the user interface 500 displays information regarding enrollment probabilities of current candidates from December 24 through March 4.

An institution user can customize the display of information for the user interface 400, 500 as shown in FIG. 6. FIG. 6 illustrates an example user interface 600 for customizing the viewing of enrollment probabilities for current candidates. For example, the institution user can choose which class of information he would like to view, how many students need to enroll to meet the recruitment cycle, and at which enrollment probability a student is considered likely to enroll. In FIG. 6, the user interface 600 shows that the data for 2013 Admit is displayed, and that the enrollment goal is 750 students. The user interface 600 also shows that a student with 60% or more enrollment probability is considered as likely to enroll.

FIG. 7A illustrates an example user interface 700 for viewing enrollment probabilities by categories. For example, an institution user may want to view the enrollment probabilities for categories such as deposits (students who paid a deposit), in-state applicants, out-of-state applicants, male or female, mid ACT (students with mid-range ACT scores), and the like. An institution user may also create a category for various counselors or administrators, such as Joan Jamison or Silvia Wilson, as illustrated in user interface 700.

FIG. 7B illustrates an example user interface 710 for customizing categories for viewing enrollment probabilities. The institution user can add categories for display and specify which students fall under each category. For example, for the deposits category, the institution user can specify that the category includes students who have paid a deposit to the institution for enrolling in the upcoming class year. In another example, for the counselor category, the institution user can specify that the category includes students that are associated with that counselor.

FIG. 8 illustrates an example user interface 800 for viewing enrollment probability of a current candidate. As shown in user interface 800, the enrollment probability for a current candidate is displayed near the current candidate's name. Other information related to the current candidate is also displayed. For example, the candidate's major, enrollment status, high school name, high school address, gender, high school GPA, phone number, counselor, deposit status, email, date joined, last login time, last post time, and the like, may be displayed. The user interface 800 displays the current candidates in a list format along with their respective information. In some embodiments, the list of current candidates and their respective information can be downloaded, for example, as an Excel spreadsheet or Word document. The institution user may choose which current candidates are displayed in the list in the user interface 800 or how the list is sorted. In some embodiments, the institution user can send an announcement or a message to specific current candidates within the user interface 800.

In this manner, systems and methods for determining an enrollment probability of a student associated with an institution is provided. Prior candidate data for a reference institution is received. The prior candidate data pertains to students that were previously considered for enrollment at the reference institution. The activity of a current candidate is monitored on a social media site. The current candidate is someone who applied to a target institution for enrollment. The enrollment probability for the current candidate is determined. The enrollment probability indicates a probability a current candidate will enroll at the target institution, and the enrollment probability is determined using prior candidate data and current candidate activity on the social media site. The reference institution and target institution may be the same institution, or they may be different institutions. The reference institution may be chosen as a representative institution, and data associated with prior candidates for the reference institution may be used to determine the enrollment probability of a current candidate for the target institution.

A plurality of reference enrollment scores is determined using the prior candidate data, where the prior candidate data is associated with a plurality of prior candidates for enrollment at the reference institution. The reference enrollment scores may be determined based on prior candidate data and institution data received from the reference institution. Institution data may include a grade point average (GPA), high school name, high school address, Scholastic Aptitude Test (SAT) scores, American College Test (ACT) scores, and deposit status. The plurality of reference enrollment scores are ranked and sorted into at least two reference bins or reference collections of enrollment scores. The ranked reference enrollment scores are sorted into reference bins or collections by segmenting the scores into a same number of groupings, where the groupings are the reference bins. A reference enrollment probability for each reference bin or collection is calculated.

An enrollment score for a current candidate is determined based on the current candidate activity on the social media site. The enrollment score is ranked and sorted into a bin. The bin is matched with a reference bin, and the enrollment probability of the current candidate is determined based on the reference enrollment probability corresponding to the matched reference bin. The enrollment score of the current candidate may be determined based on institution data received from the target institution. The enrollment probability of the current candidate is provided to the target institution. The enrollment probability of the current candidate is calculated on a daily basis.

Monitoring the current candidate's activity on the social media site includes detecting the number of friends the current candidate has on the social media site after the current candidate became a member. Monitoring the current candidate's activity includes determining an amount of information provided in the profile of the current candidate on the social media site. Monitoring the activity can also include determining a difference in a number of friends of the current candidate on the social media site before he joined the social media site and after he joined the social media site.

The social media site can be a dedicated social media site for the target institution, and the social media site can be a third party social media site. The current candidate may be invited to become a member of the social media site when or after the current candidate applies for enrollment at the target institution. The current candidate may be invited to join to the social media site when or after the current candidate is accepted for enrollment at the target institution.

Although the systems and methods herein are described as determining an enrollment probability of a student enrolling in an institution, the systems and methods may also be used to determine a probability of an applicant accepting a job with an employer or a probability of a recruit accepting a position with a corporate entity. In another example, the systems and methods described herein may also be used to determine a probability of a prospective applicant applying for enrollment at an institution, and this may help institutions in planning their recruiting efforts.

As a further example, and not as a limitation, the following steps or operations are provided as an example embodiment of the enrollment probability predictor mechanism. These steps may be included on the application server 130 of FIG. 1, or may be implemented as part of the modules 210-240 of FIG. 2. These steps may also be included as instructions 1024 on processor 1002 of computer system 1000 of FIG. 10.

```
Each day do
  # PRODUCE REFERENCE DATA:
  Each reference data school do
    Each user last year do
      last year do
        compute inputs
          (starting at enrollment cycle start, ending at today - 1 year)
        compute score
      end
    end
    rank last year's scores against scores of all last year's users
    bin last year's scores
      extract enrolled for last year's users
      for each bin of last year scores
        compute % enrolled
      end
    end
  end
Each school do
    #CHOOSE REFERENCE DATA TO USE
    if school is a reference school
      use this school's bins
    else
      use similar school's bins
    end
Each user do
      today do
        compute inputs
        compute score
      end
    end
rank today's scores against scores of all today's users this school
    for each user
      compare user rank today with bins (might use bins from a different
      school)
      produce %likelihood to enroll based on bin's %enrolled
      store %likelihood to enroll with today's date
    end
  end
end
bin last year's scores
  sort the ranks
  divide the set of ranks into n subsets (bins)
  for each bin
    record % enrolled for bin
  end
end
compute score(inputs)
  sum = 0
  for each input
    sum = sum + input * weight(input)
  end
  return sum
end
or
compute_score
  maximum value of weighted(inputs)
end
or
compute_score
  weighted average of maximum values from subsets of inputs
end
```

FIG. 9 is a diagram showing example database tables 900 and example database fields in which the methods and systems described herein may be implemented according to some embodiments. Database tables 900 and database fields may be used for storing and organizing candidate information and data derived from candidate information, according to the methods and systems described herein. The example database tables 900 and database fields may be included in database(s) 150 of system 100 of FIG. 1. Database tables 900 may include enrollment_statuses table 910 for storing candidate information related to enrollment status of the candidate. Feed_items table 920 may store candidate information and activity associated with the social media site. Enrollment_scores table 930 may store and organize information related to the enrollment score and enrollment probability of a candidate. Facebook_friendships table 940 may store information from the social media site related to a candidate's friend on the social media site. Historical requests table 950 may store and organize information from the social media site regarding friend requests and other requests on the social media site. Users table 960 may store and organize information relating to a candidate, including the candidate's name, date joined, and the like. Visits table 970 may store and organize information related to a candidate's activity on the social media site, for example, number of times user views his own profile, number of times user views other users' profiles, and the like. User_tag_keys table 980 and user_tags table 990 may store and organize candidate information. Some of the database fields may be tables themselves or may be connected to other database tables. Some database fields may be populated by the various modules described herein, and the various modules may access data from these database fields. Although only tables 910-990 are shown, database tables 900 may consist of more tables with any number of database fields. Even though tables 910-990 are shown to consist of particular database fields, tables 910-990 may comprise more or less database fields than shown, or the database fields may be of different types (integer, Boolean, datetime, float, string, etc.) or may be named differently.

In an example embodiment, the database fields from the example database tables 900 can be used to determine an enrollment score for a user according to the methods and systems described herein. For example, database fields such as friend_id, facebook_params, self_profile_view_count, and other_profile_view_count can be used to calculate an enrollment score for a candidate, and the enrollment score may be stored in database field likelihood.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 10 is a block diagram of a machine in the example form of a computer system 1000 within which instructions 1024 for causing the machine (e.g., client device 110, 115, 120, 125; server 135; database server(s) 140; database(s) 130) to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD), a touch screen, or a cathode ray tube (CRT)). The computer system 1000 also includes an alphanumeric input device 1012 (e.g., a physical or virtual keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of data structures and instructions 1024 (e.g., software) embodying or used by any one or more of the methodologies or functions described herein. The instructions 1024 may also reside, completely or at least partially, within the main memory 1004, static memory 1006, and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more data structures or instructions 1024. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present mechanism has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

It will be appreciated that, for clarity purposes, the above description describes some embodiments with reference to different functional units or processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third” and so forth are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method comprising:
receiving prior candidate data for a reference institution, the prior candidate data pertaining to students that were previously considered for enrollment at the reference institution;
monitoring activity of a current candidate on a social media site associated with a target institution including monitoring the activity from an initial time relating to the current candidate becoming a member of the social media site to a subsequent time, the current candidate having applied to the target institution;
storing data about the monitored activity of the current candidate including storing first data associated with the initial time and second data associated with the subsequent time; and
determining, by a processor, an enrollment probability indicating a probability that the current candidate will enroll at the target institution, the determining of the enrollment probability being performed using the prior candidate data and the stored data about the monitored activity of the current candidate on the social media site.

2. The method of claim 1, wherein the reference institution and the target institution are a same institution, or wherein the reference institution and the target institution are different institutions.

3. The method of claim 1, wherein the prior candidate data includes activity data on the social media site of at least one prior candidate who previously enrolled at the reference institution.

4. The method of claim 1, further comprising:
determining a plurality of reference enrollment scores using the prior candidate data, the prior candidate data associated with a plurality of prior candidates for enrollment at the reference institution;
ranking the plurality of reference enrollment scores;
sorting the plurality of reference enrollment scores into at least two reference collections of reference enrollment scores, wherein the sorting comprises segmenting the plurality of reference enrollment scores into a same number of groupings forming the reference collections of reference enrollment scores based on the ranking of the plurality of reference enrollment scores; and
determining a reference enrollment probability for each of the reference bins.

5. The method of claim 4, further comprising:
receiving institution data from the reference institution, the institution data associated with the plurality of prior candidates of the reference institution; and
determining the plurality of reference enrollment scores based on the prior candidate data and the institution data.

6. The method of claim 5, wherein the institution data associated with the plurality of prior candidates of the reference institution comprises at least one of a grade point average (GPA), high school name, high school address, Scholastic Aptitude Test (SAT) scores, American College Test (ACT) scores, and deposit status.

7. The method of claim 4, further comprising:
receiving institution data from the target institution, the institution data associated with the current candidate;
determining an enrollment score for the current candidate based on the current candidate activity on the social media site and the institution data;
ranking the enrollment score among a plurality of enrollment scores;
sorting the plurality of enrollment scores into collections of enrollment scores based on the ranking;
matching the collection consisting of the enrollment score of the current candidate to one of the reference collections; and
determining the enrollment probability for the current candidate based on the matching.

8. The method of claim 1, wherein the monitoring of the activity of the current candidate includes detecting a number of friends of the current candidate after the current candidate becomes a member of the social media site.

9. The method of claim 1, wherein the monitoring of the activity of the current candidate includes determining an amount of information provided in a profile of the current candidate on the social media site.

10. The method of claim 1, wherein the monitoring of the activity of the current candidate includes determining a difference in a number of friends of the current candidate before the current candidate became a member of the social media site and after the current candidate became a member of the social media site.

11. The method of claim 1, wherein the social media site is a dedicated social media site for the target institution.

12. The method of claim 1, wherein the current candidate is invited to become a member of the social media site in response to the current candidate applying for enrollment at the target institution.

13. The method of claim 1, wherein the current candidate is invited to become a member of the social media site in response to the current candidate being accepted by the target institution.

14. The method of claim 1, wherein the enrollment score is determined on a daily basis.

15. A system comprising:
a data collection module configured to:
receive prior candidate data for a reference institution, the prior candidate data pertaining to students that were previously considered for enrollment at the reference institution;
monitor activity of a current candidate on a social media site associated with a target institution including monitoring the activity from an initial time relating to the current candidate becoming a member of the social media site to a subsequent time, the current candidate having applied to the target institution;
storing data about the monitored activity of the current candidate including storing first data associated with the initial time and second data associated with the subsequent time; and
a processor implemented enrollment prediction module configured to:
determine an enrollment probability indicating a probability that the current candidate will enroll at the target institution, the determining of the enrollment probability being performed using the prior candidate data and the stored data about the monitored activity of the current candidate on the social media site.

16. The system of claim 15, further comprising a reference data module configured to:
determine a plurality of reference enrollment scores using the prior candidate data, the prior candidate data associated with a plurality of prior candidates for enrollment at the reference institution;
rank the plurality of reference enrollment scores;
sort the plurality of reference enrollment scores into at least two reference collections of reference enrollment scores, wherein the sorting comprises segmenting the plurality of reference enrollment scores into a same number of groupings forming the reference collections based on the ranking of the plurality of reference enrollment scores; and
determine a reference enrollment probability for each of the reference bins.

17. The system of claim 16, wherein the data collection module is further configured to receive institution data from the reference institution, the institution data associated with the plurality of prior candidates of the reference institution; and
the reference data module is further configured to determine the plurality of reference enrollment scores based on the prior candidate data and the institution data.

18. The system of claim 17, wherein the processor implemented enrollment prediction module is further configured to:
determine an enrollment score for the current candidate based on the current candidate activity on the social media site;
ranking the enrollment score among a plurality of enrollment scores;
sorting the plurality of enrollment scores into collections of enrollment scores based on the ranking;
matching the collection consisting of the enrollment score of the current candidate to one of the reference collections; and
determining the enrollment probability for the current candidate based on the matching.

19. The system of claim 15, further comprising a display configuration module configured to provide the enrollment probability to the target institution.

20. A non-transitory machine-readable medium comprising a set of instructions that, when executed by a processor, causes the processor to perform operations, the set of instructions comprising:
receiving prior candidate data for a reference institution, the prior candidate data pertaining to students that were previously considered for enrollment at the reference institution;
monitoring activity of a current candidate on a social media site associated with a target institution including monitoring the activity from an initial time relating to the current candidate becoming a member of the social media site to a subsequent time, the current candidate having applied to the target institution;
storing data about the monitored activity of the current candidate including storing first data associated with the initial time and second data associated with the subsequent time; and
determining an enrollment probability indicating a probability that the current candidate will enroll at the target institution, the determining of the enrollment probability being performed using the prior candidate data and the stored data about the monitored activity of the current candidate on the social media site.

21. A method comprising:
receiving prior candidate data for a reference institution, the prior candidate data pertaining to students that were previously considered for enrollment at the reference institution;
monitoring activity of a current candidate on a social media site associated with a target institution including monitoring the activity from an initial time relating to the current candidate becoming a member of the social media site to a subsequent time, the current candidate having applied to the target institution, wherein the monitoring of the activity of the current candidate includes determining a difference in a number of friends of the current candidate before the current candidate became a member of the social media site and after the current candidate became a member of the social media site;
storing data about the monitored activity of the current candidate including storing first data associated with the initial time and second data associated with the subsequent time; and
determining, by a processor, an enrollment probability indicating a probability that the current candidate will enroll at the target institution, the determining of the enrollment probability being performed using the prior candidate data and the stored data about the monitored activity of the current candidate on the social media site.

22. The method of claim 21, wherein the monitoring of the activity of the current candidate includes detecting the number of friends of the current candidate after the current candidate becomes a member of the social media site.

23. The method of claim 21, wherein the monitoring of the activity of the current candidate includes determining an amount of information provided in a profile of the current candidate on the social media site.
